(19) United States
(12) Patent Application Publication
(10) Pub. No.: US 2026/0177384 A1
(43) Pub. Date: Jun. 25, 2026

(54) ELECTRONIC SYSTEM WITH EYEWEAR DEVICE

(71) Applicant: ThinkAR Pte Ltd., Taipei City (TW)

(72) Inventor: Zhou Ye, Taipei City (TW)

(73) Assignee: ThinkAR Pte Ltd., Taipei City (TW)

(21) Appl. No.: 18/988,912

(22) Filed: Dec. 20, 2024

(51) Int. Cl. G01C 21/20; G06K 7/14; G06V 20/20

(52) U.S. Cl. CPC G01C 21/20; G06V 20/20; G06K 7/1413

(57) ABSTRACT

The electronic system of the disclosure includes an eyewear device and an external device. The eyewear device comprises a sensor and a first processing unit. The sensor is configured to collect an input information. The external device is coupled to the eyewear device. The external device comprises a second processing unit. At least one of the first processing unit and the second processing unit is configured to process the input information, and a first operating speed of the first processing unit is slower than a second operating speed of the second processing unit.

### BACKGROUND

### 1. Technical Field

The disclosure generally relates to a system, and more particularly, to an electronic system with an eyewear device.

### 2. Description of Related Art

With the population of augmented reality (AR) and virtual reality (VR), smart eyewear has become a trending electronic device for people to emerge themselves in a different world. However, due to computation capabilities and power consumptions, the smart eyewear is usually equipped with heavy battery and processing circuits, which makes it difficult for users to wear for a long period of time.

### SUMMARY

Accordingly, the disclosure is directed to an electronic system which reduces the weight of the eyewear device while preserving computation capabilities of the electronic system.

The electronic system of the disclosure includes an eyewear device and an external device. The eyewear device comprises a sensor and a first processing unit. The sensor is configured to collect an input information. The external device is communicatively coupled to the eyewear device. The external device comprises a second processing unit. At least one of the first processing unit and the second processing unit is configured to process the input information, and a first operating speed of the first processing unit is slower than a second operating speed of the second processing unit.

The eyewear device is adapted to be coupled to an external device. The eyewear device comprises a sensor and a first processing unit. The sensor is configured to collect an input information. The first processing unit is configured to process the input information with a second processing unit of the external device to generate a display information, and a first operating speed of the first processing unit is slower than a second operating speed of the second processing unit.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a block diagram of an electronic system in accordance with some embodiments of the present disclosure.

FIG. 2A illustrates a block diagram of a first processing unit in accordance with some embodiments of the present disclosure.

FIG. 2B illustrates a block diagram of a first processing unit in accordance with some embodiments of the present disclosure.

FIG. 3A illustrates a block diagram of a second processing unit in accordance with some embodiments of the present disclosure.

FIG. 3B illustrates a block diagram of a second processing unit in accordance with some embodiments of the present disclosure.

### DESCRIPTION OF THE EMBODIMENTS

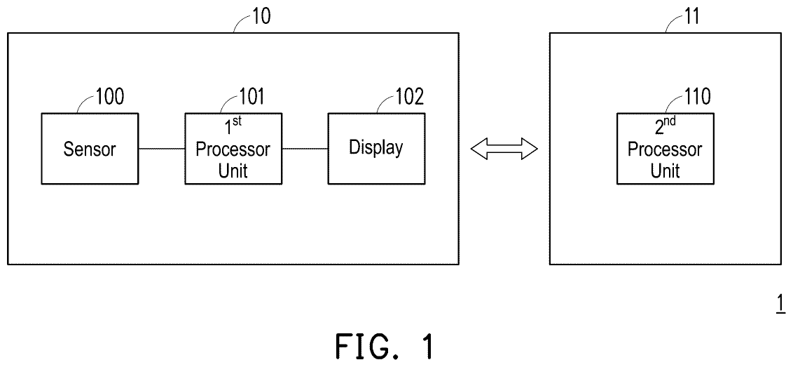

FIG. 1 illustrates a block diagram of an electronic system 1 in accordance with some embodiments of the present disclosure. The electronic system 1 includes an eyewear device 10 and an external device 11. The eyewear device 10 is coupled to the external device 11. In some embodiments, the eyewear device 10 is electrically coupled to the external device 11, for example, through a cable. In another embodiments, the eyewear device 10 is communicatively coupled to the external device 11. The eyewear device 10 may be configured to collect an input information, and at least one of the eyewear device 10 and the external device 11 may be used to process the input information to generate a display information. In this way, the eyewear device 10 may be configured to display according to the display information, providing visual aids to a user wearing the eyewear device 10.

Specifically, the eyewear device 10 includes a sensor 100, a first processing unit 101, and a display 102. The external device 11 includes a second processing unit 110. The sensor 100 may be configured to collect the input information. The sensor 100 may be, for example but not limited to, a camera, a microphone, a radio frequency (RF) signal receiver, etc., which may be utilized to collect an information from the surrounding environment or an inputted signal. In different scenario, the input information may be adaptively provided to at least one the first processing unit 101 and the second processing unit 110 for analyzing the input information to generate the display information for the display 102 to display according to the display information. More particularly, the first processing unit 101 disposed in the eyewear device 10 may be designed to have a slower first operating speed, while the second processing unit 110 disposed in the external device 11 may be designed to have a faster second operating speed. For example, the first processing unit 101 is a micro control unit (MCU) that has a slower operating speed and is optimized for low-power or less computationally demanding tasks, and the second processing unit 110 is a central processing unit (CPU) that has a faster operating speed and is designed for high-performance tasks. In this way, analyzing the input information may be carried out by at least one of the first processing unit 101 and the second processing unit 110 based on complexity of the task. For example, when analysis on the input information is easy, the first processing unit 101 may be responsible for analyzing the input information. When analysis on the input information is complexed and more power consuming, the second processing unit 110 may be responsible for analyzing the input information. In some other examples, analysis on the input information may be divided into multiple tasks, and easier tasks may be assigned to the first processing unit 101 while more complexed tasks may be assigned to the second processing unit 110. By assigning the more complexed analysis operations to the second processing unit 110 of the external device 11 rather than the first processing unit 101 of the eyewear device 10, computation and power requirements of the eyewear device 10 may be significantly relieved, further reducing the power consumption of the eyewear device 10, increasing battery life of the eyewear device 10, and reducing a weight of the eyewear device 10 as well as improving user's comfort in putting on the eyewear device 10.

Examples of the first processing unit 101 may be a central processing unit (CPU), or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA), any other type of integrated circuit, state machine, advanced RISC machine (ARM) processor, or other suitable components or combinations of the above, and examples of the second processing unit 110 may be a central processing unit (CPU), or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA), any other type of integrated circuit, state machine, advanced RISC machine (ARM) processor, or other suitable components or combinations of the above, as long as the operating speed of the second processing unit 110 is faster than that of the first processing unit 101.

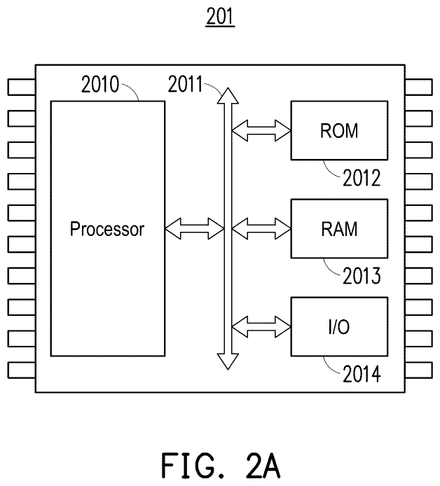

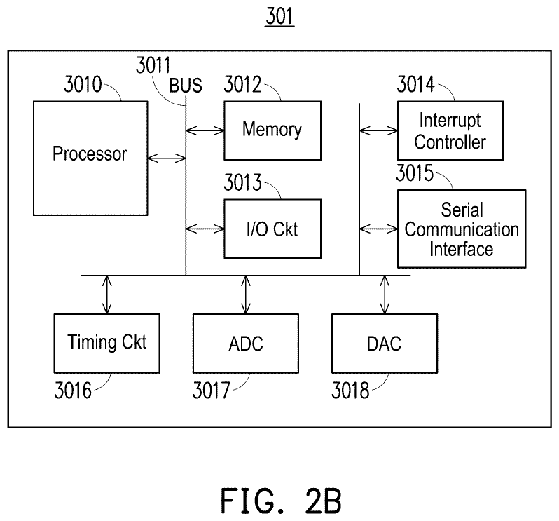

FIG. 2A illustrates a block diagram of a first processing unit 201 in accordance with some embodiments of the present disclosure. The first processing unit 201 may be utilized in the eyewear device 10 to replace the first processing unit 101 as depicted in FIG. 1. The first processing unit 201 includes a processor 2010, a bus 2011, a read-only memory (ROM) 2012, a random-access memory (RAM) 2013, and input/output (I/O) circuit 2014.

The first processing unit 201 may be an MCU. The bus 2011 is coupled to the processor 2010, the ROM 2012, RAM 2013, and the I/O circuit 2014 to enable data transmission within the first processing unit 201. More particularly, the processor 2010 may be configured to access data with the ROM 2012, RAM 2013, and the I/O circuit 2014 through the bus 2011.

FIG. 2B illustrates a block diagram of a first processing unit 301 in accordance with some embodiments of the present disclosure. Similarly, the first processing unit 301 may be utilized in the eyewear device 10 to replace the first processing unit 101 as depicted in FIG. 1. The first processing unit 301 includes a processor 3010, a bus 3011, a memory 3012, an I/O circuit 3013, an interrupt controller 3014, a serial communicate interface 3015, a timing circuit 3016, an analog-to-digital converter (ADC) 3017, and a digital-to-analog converter (DAC) 3018.

The first processing unit 301 may be an MCU. The bus 3011 is coupled to the processor 3010, the memory 3012, the I/O circuit 3013, the interrupt controller 3014, the serial communicate interface 3015, the timing circuit 3016, the analog-to-digital converter (ADC) 3017, and the digital-to-analog converter (DAC) 3018 to enable data transmission within the first processing unit 301. More particularly, the processor 3010 may be configured to access data with the memory 3012 and the I/O circuit 3014 through the bus 3011. Examples of the memory 3012 may include read-only memory (ROM), random access memory (RAM) devices such as dynamic RAM (DRAM), synchronous DRAM (SDRAM), solid state memory devices, and/or a variety of other memory devices known in the art. The I/O circuit 3013 may be configured to support the same or different interface protocols, for example but not limited to, universal asynchronous receiver/transmitter (UART), watch dog timer (WDT), general purpose input/output (GPIO), inter-integrated circuit (I2C), integrated inter-chip sound (I2S), etc. The interrupt controller 3014 may be configured to inform the processor 3010 whether an interrupt is occurred. The serial communication interface 3015 may allow the first processing unit 301 of serialized data transmission, such as RS-232, universal serial bus (USB), etc. Further, although not clearly illustrated, the ADC 3017 may be coupled to a sensor to convert the analog signal received from the sensor into a digital signal. The DAC 3018 may be configured to convert the processed digital signal into an analog signal for an output device. Examples of the timing circuit 3016 may include a real time clock (RTC) circuit, a counter, etc., which may be capable of providing a timing information.

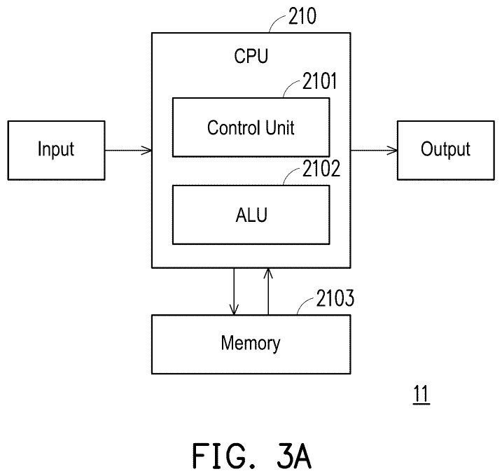

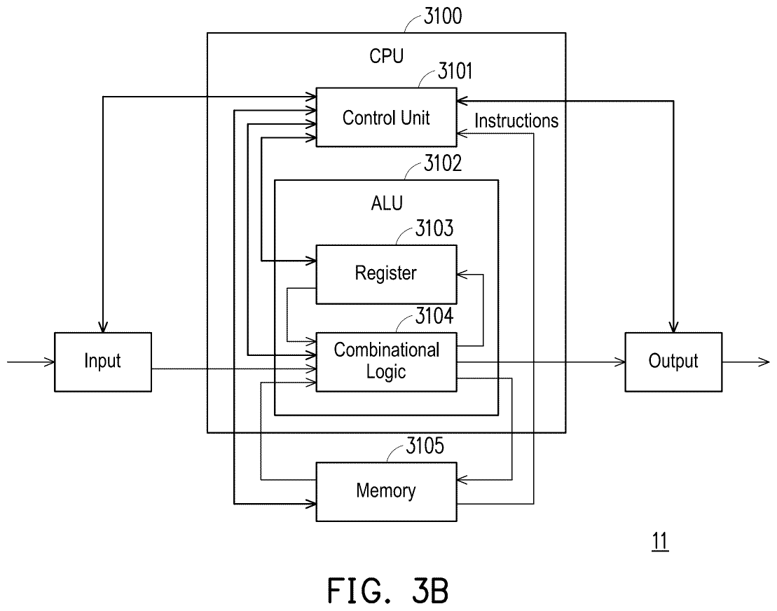

FIG. 3A illustrates a block diagram of the external device 11 as depicted in FIG. 1 in accordance with some embodiments of the present disclosure. A second processing unit 210 may be utilized in the external device 11 to replace the second processing unit 110 as depicted in FIG. 1.

As shown in FIG. 3A, the external device 11 includes the second processing unit 210 and a memory 2103. In some embodiments, the second processing unit 210 is a CPU. The second processing unit 210 includes a control unit 2101 and an arithmetic logic unit (ALU) 2102. Examples of the memory 2103 may include ROM, random access memory (RAM) devices such as dynamic RAM (DRAM), synchronous DRAM (SDRAM), solid state memory devices, and/or a variety of other memory devices known in the art. The control unit 2101 executes instructions by following a series of steps known as the instruction execution cycle. It fetches the next instruction from memory 2103, decodes the instruction to understand its operation, fetches any required data from memory 2103, performs the necessary operations using the ALU 2102, and finally stores the results back into memory or registers.

FIG. 3B illustrates a block diagram of the external device 11 as depicted in FIG. 1 in accordance with another embodiments of the present disclosure. A second processing unit 3100 may be utilized in the external device 11 to replace the second processing unit 110 as depicted in FIG. 1.

As shown in FIG. 3B, the external device 11 includes the second processing unit 3100 and a memory 3105. In some embodiments, the second processing unit 3100 is a CPU. The second processing unit 3100 includes a control unit 3101 and an ALU 3102. The ALU 3102 includes registers 3103 and a combinational logic 3104. Examples of the memory 3105 may include ROM, random access memory (RAM) devices such as dynamic RAM (DRAM), synchronous DRAM (SDRAM), solid state memory devices, and/or a variety of other memory devices known in the art. The combinational logic 3104 together with the register 3103 may be configured to realize simple math functions, for example but not limited to, addition, multiplication, etc. The control unit 3101 executes instructions by following a series of steps known as the instruction execution cycle. It fetches the next instruction from memory 3105, decodes the instruction to understand its operation, fetches any required data from memory 3105, performs the necessary operations using the ALU 3102, and finally stores the results back into memory or registers.

In some embodiments, the electronic system 1 may be used for navigation. At first, a target location may be input to external device 11 by the user. For the navigation purpose, the second processing unit 110 requires a current location for determining a route to the target location. In some embodiment, the sensor 100 may be a camera used to capture a front image of the eyewear device 10 as the input information. In this way, the front image may be provided to the second processing unit 110 for performing an image recognition operation to determine a current location where the user is, and a current direction of which way the user is facing. The second processing unit 110 may be configured to plan a route from the current location to the target location. In order to guide the user to the target location step by step, the second processing unit 110 may be configured to generate a navigation information on how the user should move next according to the planned route, the current location and the current direction of the user. The navigation information may be provided to the eyewear device 10 for informing the user.

In some embodiments, the display 102 may be lenses on the eyewear device 10, and the navigation information may be displayed on the lenses for the user to read. In this way, the user may conveniently move toward the target location based on instructions shown on the display 102. For example, the navigation information may include a moving distance information “turn right” and a moving direction information “200 meters”. When the first processing unit 101 receives the moving distance information and the moving direction information, the first processing unit 101 may be configured to control the display to show the navigation information to the user.

In some embodiments, how the second processing unit 110 is configured to generate the navigation information may be modified or altered based on different requirements. For example, when the external device 11 has a global positioning system (GPS) to provide such current location and current direction of the external device 11, the second processing unit 110 may be configured to generate the navigation information using the current location and the current direction, and the first processing unit 101 may control the display 102 to display the navigation information, including the moving distance information and the moving direction information, to guide the user. In some embodiments, the first processing unit 101 may be configured to show the moving distance information and the moving direction information at suitable positions with a proper direction icon in the front image. For example, when first processing unit 101 receives the moving distance information “turn right” and the moving direction information “200 meters,” the first processing unit 101 may analyze the front image to put a the “turn right” icon at a 200 meters depth position in the front image.

In some embodiments, the second processing unit 110 of the external device 11 may be configured to compute and output text information for display. The first processing unit 101 may be configured to receive and curate the text information, and control the display 102 to display a corresponding image.

In some embodiments, the sensor 100 may be a microphone and configured to capture audio information from the user and/or environment. The captured audio information may be sent to the first processing unit 101, and further to the second processing unit 110 of the external device 11, for processing the audio information. For example, the second processing unit 110 may be configured to convert the audio information into a text information. The text information may be then used by the first processing unit 101 to display on the display 102. In this way, the audio-to-text conversion process may be used to provide visual aids to hearing-impaired users.

In some embodiments, the sensor 100 may be a microphone and configured to collect an audio information from the user and/or environment. The captured audio information may be provided to the first processing unit 101 to convert the audio into a text information. The converted text information may be sent to the second processing unit 110 of the external device 11 for processing. For example, the text information may include a predetermined command, such as dialing to a certain contact, searching information from internet, etc., so that that the second processing unit 110 may be configured to perform the command. In some embodiments, in response to the second processing unit 110 performing the command, the first processing unit 101 may be configured to control the display 102 to display a corresponding command icon in the front image.

In some embodiment, the sensor 100 may be a camera and configured to capture a front image of the eyewear device 10. The first processing unit 101 may be configured to perform an image recognition on the front image to see whether the front image carries a predetermined pattern. For example, the first processing unit 101 may be configured to determine whether there are any barcodes appeared in the front image. If so, the first processing unit 101 may provide the barcode to the second processing unit 110 for analysis. In some embodiment, the first processing unit 101 may also be utilized to analyze the barcode. For example, the first processing unit 101 may also be utilized to analyze the barcode, to convert the barcode into a Uniform Resource Locator (URL) information, and provide the URL information to the second processing unit 110. The second processing unit 110 may visit and obtain a website information according to the URL, and provide the website information to the first processing unit 101 for displaying it on the lenses.

In some embodiments, the first processing unit 101 may be coupled to a wireless transceiver, the external device also has a wireless transceiver, and the wireless transceivers are configured to communicate with each other.

In summary, the electronic system provides the eyewear device and the external device. By providing the first processing unit in the eyewear device with a slower operating speed and the second processing unit in the external device with a faster operating speed, power consumption and weight of the eyewear device can be significantly reduced. Meanwhile, the external device may be used to complement the computing capabilities of the eyewear device. As a result, the electronic system may improve the user's comfort in wearing the eyewear device without affecting the overall computational capability.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic system, comprising:
an eyewear device, comprising:
a sensor configured to collect an input information; and
a first processing unit; and
an external device coupled to the eyewear device, the external device comprising:
a second processing unit,
wherein at least one of the first processing unit and the second processing unit is configured to process the input information, and a first operating speed of the first processing unit is slower than a second operating speed of the second processing unit.

2. The electronic system of claim 1, wherein the eyewear device comprises a display, wherein at least one of the first processing unit and the second processing unit is configured to analyze the input information to generate a display information, and the display is configured to show the display information.

3. The electronic system of claim 1, wherein the input information is a front image of the eyewear device, and the second processing unit is configured to perform a navigation operation to generate a moving distance information and a moving direction information to the first processing unit.

4. The electronic system of claim 3, wherein the eyewear device comprises a display, and the first processing unit is configured to control the display to show the moving distance information and the moving direction information.

5. The electronic system of claim 4, wherein the first processing unit is configured to control the display showing a direction icon according to the moving distance information and the moving direction information.

6. The electronic system of claim 1, wherein the sensor is a microphone and configured to collect an audio information, the second processing unit is configured to convert the audio information into a text information, and the first processing unit is configured to control the display to show the text information.

7. The electronic system of claim 1, wherein the sensor is a microphone and configured to collect an audio information, the first processing unit is configured to convert the audio information into a text information, when the text information comprises a predetermined command, the second processing unit is configured to perform the predetermined command.

8. The electronic system of claim 1, wherein the sensor is a camera, the first processing unit is configured to determine whether an image captured by the sensor comprises a predetermined pattern, when the first processing unit determines that the predetermined pattern is comprised in the image, at least one of the first processing unit and the second processing unit is configured to analyze the predetermined pattern.

9. The electronic system of claim 8, wherein the predetermined pattern is a barcode.

10. The electronic system of claim 1, wherein when the first processing unit determines that the predetermined pattern corresponds to a Uniform Resource Locator (URL) information, the first processing unit is configured to provide the URL information to the second processing unit, and the second processing unit is configured to obtain a website information according to the URL information for the eyewear device to display.

11. An eyewear device adapted to be coupled to an external device, the eyewear device comprising:
a sensor configured to collect an input information; and
a first processing unit, wherein the first processing unit is configured to process the input information with a second processing unit of the external device to generate a display information, and a first operating speed of the first processing unit is slower than a second operating speed of the second processing unit.

12. The eyewear device of claim 11, comprising a display, wherein the first processing unit and the second processing unit are configured to analyze the input information to generate the display information, and the display is configured to show the display information.

13. The eyewear device of claim 11, wherein the input information is a front image of the eyewear device, and the second processing unit is configured to perform a navigation operation to generate a moving distance information and a moving direction information to the first processing unit.

14. The eyewear device of claim 13, comprising a display, and the first processing unit is configured to control the display to show the moving distance information and the moving direction information.

15. The eyewear device of claim 14, wherein the first processing unit is configured to control the display showing a direction icon according to the moving distance information and the moving direction information.

16. The eyewear device of claim 11, wherein the sensor is a microphone and configured to collect an audio information, the second processing unit is configured to convert the audio information into a text information, and the first processing unit is configured to control the display to show the text information.

17. The eyewear device of claim 11, wherein the sensor is a microphone and configured to collect an audio information, the first processing unit is configured to convert the audio information into a text information, when the text information comprises a predetermined command, the second processing unit is configured to perform the predetermined command.

18. The eyewear device of claim 11, wherein the sensor is a camera, the first processing unit is configured to determine whether an image captured by the sensor comprises a predetermined pattern, when the first processing unit determines that the predetermined pattern is comprised in the image, the second processing unit is configured to analyze the predetermined pattern.

19. The eyewear device of claim 18, wherein the predetermined pattern is a barcode.

20. The eyewear device of claim 11, wherein when the first processing unit determines that the predetermined pattern corresponds to a Uniform Resource Locator (URL) information, the first processing unit is configured to provide the URL information to the second processing unit, and the second processing unit is configured to obtain a website information according to the URL information for the eyewear device to display.
